(19) United States
(12) Patent Application Publication
(10) Pub. No.: US 2025/0307197 A1
(43) Pub. Date: Oct. 2, 2025

(54) AI Accelerator Cores with Integrated CPU for External Communication Over Ethernet

(71) Applicant: Tenstorrent USA, Inc., Austin, TX (US)

(72) Inventors: Richard David Roze, Toronto (CA); Michael Smith, Toronto (CA)

(21) Appl. No.: 19/093,258

(22) Filed: Mar. 28, 2025

Related U.S. Application Data
(60) Provisional application No. 63/572,260, filed on Mar. 30, 2024.

(51) Int. Cl. G06F 13/42

(52) U.S. Cl. CPC G06F 13/42

(57) ABSTRACT

A multicore processor includes a Network-on-Chip (NoC) that coordinates operations of a set of AI accelerator cores. The multicore processor also includes a central processing unit (CPU) that accesses information regarding the operation of the AI accelerator cores via the NoC. Based on this information the CPU determines that an operation of the AI accelerator cores requires information that is accessible from a system that is accessible over an Ethernet link. Rather than accessing the Ethernet link through a bus and host associated with the multicore processor, the multicore processor includes an Ethernet node that establishes and maintains direct communications over the Ethernet link. The CPU administers the configuration and operation of the Ethernet node based on the requirements of the AI accelerator nodes.

### CROSS REFERENCE TO RELATED APPLICATIONS

This application claims the benefit of U.S. Provisional Patent Application No. 63/572,260, as filed on Mar. 30, 2024, which is incorporated by reference herein in its entirety for all purposes.

### BACKGROUND

Many computing systems that are directed to accelerating artificial intelligence workloads, such as the execution of an artificial neural network (ANN) use the paradigm of distributed parallel computing embodied by, for example, a multicore processor. More generally, these systems can be referred to as a network of computational nodes. In a multicore processor, collaboration among multiple cores is essential for efficiently executing ANNs. The parallel architecture of multicore processors allows for simultaneous processing of different portions of the ANN, significantly speeding up training and inference tasks. During the execution of an ANN, various layers and operations can be divided among the available cores, enabling concurrent computation and reducing overall processing time. The cores collaborate through efficient communication mechanisms, such as Networks-on-Chips (NoCs). Coordinated data sharing and synchronization mechanisms are implemented to ensure that intermediate results are exchanged seamlessly, enabling the collective execution of complex neural network models. This collaborative approach optimizes the utilization of available computational resources, enhances parallelism, and contributes to the overall acceleration of AI workloads on multicore processors.

However, despite the advantages of parallelism in multicore processors for ANN execution, efficient data sharing among cores presents a significant challenge. Coordinating the flow of data, particularly data associated with large quantities of network data and intermediate results in the form of activation data, requires careful consideration of communication overhead and synchronization. The interconnectedness of processing cores in a multicore system demands sophisticated communication architectures, like NoCs, to manage the exchange of information without introducing bottlenecks. Balancing the distribution of tasks across cores and minimizing data movement latency is crucial for achieving optimal performance.

### SUMMARY

In specific embodiments, a multicore processor comprises a set of artificial intelligence (AI) accelerator cores, at least one Ethernet node, and at least one central processing unit (CPU). The multicore processor further comprises a NoC that networks the set of AI accelerator cores, the at least one Ethernet node, and the CPU. The CPU executes instructions to administrate Ethernet transfers over an Ethernet link for the set of artificial intelligence accelerator cores using the Ethernet node.

In specific embodiments, a method for a multicore processor to directly communicate via an Ethernet link comprises monitoring, by a NoC, a set of AI accelerator cores and determining, by a central processing unit of the multicore processor based on the monitoring, that the AI accelerator cores require information that is available via the Ethernet link. The method further comprises generating, by the CPU, a message for transmission via the Ethernet link and providing, by the CPU via the NoC, the message for transmission to an Ethernet node of the multicore processor. The method further comprises processing, by the Ethernet node, the message for transmission as packets for transmission over the Ethernet link, and transmitting, by the Ethernet node, the packets over the Ethernet link.

In specific embodiments, an artificial intelligence processing system comprises a host processor, a first Ethernet link connected to the host processor, and a multicore processor in communication with the host processor. The multicore processor comprises a set of artificial intelligence AI accelerator cores, at least one Ethernet node, at least one central processing unit, and a NoC that networks the set of AI accelerator cores, the at least one Ethernet node, and the CPU. The CPU executes instructions to administrate Ethernet transfers over a second Ethernet link directly accessible to the multicore processor for the set of artificial intelligence accelerator cores using the Ethernet node. The Ethernet transfers are performed without utilizing the host processor or the first Ethernet link.

### BRIEF DESCRIPTION OF THE DRAWINGS

FIG. 1 includes a block diagram of a multicore processor coupled to a host in accordance with the related art.

FIG. 2 includes a block diagram of a multicore processor and a direct communication node for direct communication with a direct communication link in accordance with embodiments of the present disclosure.

FIG. 3 includes a block diagram of an Ethernet node interfacing between a network on chip (NoC) of a multicore processor and an Ethernet link in accordance with embodiments of the present disclosure.

FIG. 4 includes a block diagram of an Ethernet node and components thereof interfacing between a NoC of a multicore processor and an Ethernet link in accordance with embodiments of the present disclosure.

FIG. 5 includes a flow chart for methods for a NoC interfacing between a CPU and AI accelerator cores of a multicore processor for providing direct communications with an external communication link in accordance with embodiments of the present disclosure.

FIG. 6 includes a flow chart for methods for a multicore processor communicating data from a NoC to an Ethernet link via an Ethernet node in accordance with embodiments of the present disclosure.

FIG. 7 includes a flow chart for methods for a multicore processor communicating from an Ethernet link to a NoC via an Ethernet node in accordance with embodiments of the present disclosure.

### DETAILED DESCRIPTION

Systems and methods related to networks of computational nodes for the execution of artificial intelligence workloads are disclosed herein. The methods and systems disclosed in this section are nonlimiting embodiments of the invention, are provided for explanatory purposes only, and should not be used to constrict the full scope of the invention. Although the specific examples provided in this section are directed to a network of computational nodes in the form of a NoC connecting a set of AI accelerator cores, the approaches disclosed herein are broadly applicable to networks connecting any form of computational nodes. In specific embodiments, the computational nodes in the networks of computational nodes can be processing cores in a multicore processor. The networks of computational nodes can include a plurality of AI accelerator nodes such as tensor processing units, matrix multiplication accelerators, and various other types of nodes for AI acceleration. The plurality of AI accelerator nodes can be homogeneous or heterogeneous. In addition to the plurality of AI accelerator nodes, the network of computational nodes can include at least one general purpose processor (e.g., a central processing unit or CPU) and at least one direct communication node such as an Ethernet communication node. In specific embodiments, the general-purpose processor can administrate data transfers on an Ethernet communication link using the Ethernet communication node and on behalf of the AI accelerator nodes.

The computational nodes in the networks of computational nodes disclosed herein can be networked together using a proprietary protocol. For example, a proprietary network on chip (NoC) protocol can be used to network the network of computational nodes. The network could be connected to the outside world via a host using one or more external connections such as a PCIe bus or some other interface for connecting computers with peripherals. As such, workloads could be transferred into the network using such an external connection, the workload could be conducted by the network of computational nodes using the proprietary protocol to exchange data, and the result of the workload could then be transferred out of the network using the external connection.

In specific embodiments of the invention, the network of computational nodes can be executing a complex computation using the AI accelerator nodes on behalf of a host. In these embodiments, the network of computational nodes can still access external systems for data lookups etc. through an Ethernet link using an Ethernet communication node that is a component of the multicore processor including the AI accelerator nodes, rather than accessing the Ethernet link through the host. The network of computational nodes can directly utilize an external Ethernet link to access and deliver information without having to notify or work with the host to establish or otherwise configure communications with the Ethernet link. In general, the network of computational nodes can be capable of communicating with external nodes over an Ethernet link without using a PCIe interface and host or equivalent connections even though the network of computational nodes is networked using a proprietary NoC protocol.

In specific embodiments, the general-purpose CPU will administrate transfers of data to and from the network of computational nodes by formulating instructions to configure the Ethernet node of the multicore processor and by administrating transfers of data to and from the Ethernet node. In specific embodiments the general-purpose processor will be a fully functional CPU. For example, the general-purpose processor could be a RISC-V processor. The general-purpose processor could be capable of implementing a full Linux stack. In addition, the general-purpose processor could be configured to network with the other nodes in the network of computational nodes using a NoC protocol. It could also have enough intelligence and computational power to enable the Ethernet subsystem node to provide a full suite of Ethernet functionality to the network of computational nodes including numerous protocols such as TCP, UDP, etc.

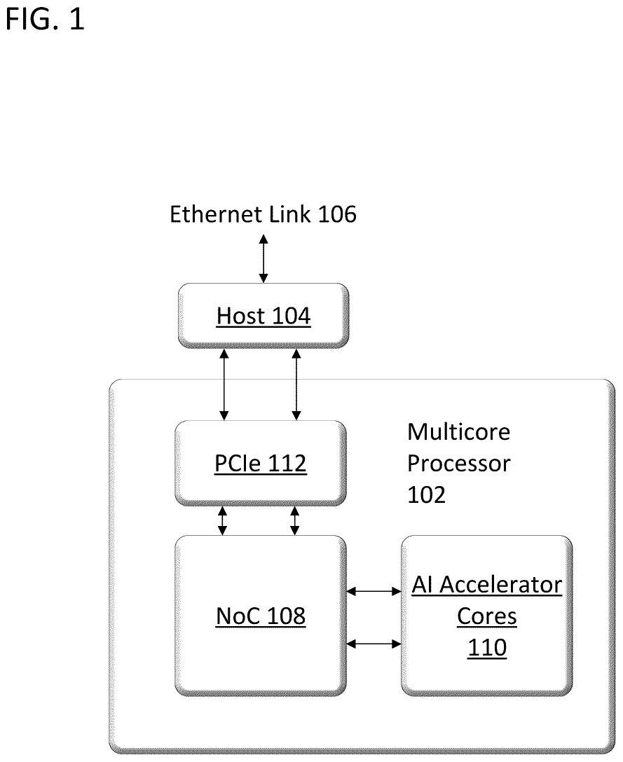

FIG. 1 includes a block diagram of a multicore processor 102 coupled to a host 104 in accordance with the related art. Host 104 can be a suitable computing system (e.g., a CPU) that coordinates and controls computational operations of multicore processor 102 such as by assigning computational tensor operations to multicore processor 102 for execution, coordinating memory and data transfers to multicore processor 102, and synchronizing and controlling multicore processor 102 tasks in coordination with other multicore processors, hosts, or computing units. In this manner, multicore processor 102 is used by host 104 to conduct an artificial intelligence workload and is configured to accelerate the processing of the artificial intelligence workload.

Multicore processor 102 can include a variety of components such as processing cores, CPUs, communication interfaces, memory units and types, control and communication paths and buses, and other types of circuitry, devices, and components. In the block diagram depicted in FIG. 1, multicore processor 102 includes a Network-on-Chip (NoC) 108, AI accelerator cores 110, and PCIe interface 112, although it will be understood that other components and configurations of a multicore processor 102 can be utilized consistent with the present disclosure. The AI accelerator cores 110 can be matrix multiply or multiply accumulate units.

NoC 108 provides a processing and communication infrastructure implemented and distributed over components of the multicore processor 102, such as routers and network interface units (NIUs) implemented such as on individual accelerator cores 210, physical links and buffers, network interfaces, processing elements, and other suitable hardware. NoC 108 can be implemented in a variety of suitable topologies, such as mesh, torus, ring, tree, fat-tree, and custom and proprietary topologies. NoC 108 (e.g., utilizing a proprietary protocol) manages data movement between AI accelerator cores 110, other processing elements, memory, and other hardware components, for example, by distributing data to AI accelerator cores 110, managing execution flow and synchronization between AI accelerator cores 110, interfacing with memory of the multicore processor 102 (e.g., of AI accelerator cores 110 and other memory, not depicted), and aggregating or otherwise processing data from cores for provision to the host 104. In this manner, NoC 108 has access to and processes detailed information regarding the AI accelerator cores and their operation, including data available at individual nodes, operations being performed at individual nodes, instructions and control signals being provided to individual nodes, node configurations, memory status and configuration, and other related information.

The NoC 108 of multicore processor 102 communicates with the host 104 over a suitable communication host such as Peripheral Component Interconnect Express (PCIe) interface 112, although other types of interfaces and/or combinations thereof can be utilized in certain configurations (e.g., non-uniform memory access (NUMA), high-speed busses such as NVLink, Infinity Fabric, etc., and shared or direct memory access). In order to communicate with an external link such as Ethernet link 106, data or other information is transmitted from the NoC 108 to the host via the PCIe interface 112, with the host managing communications with the Ethernet link 106, such as establishing a link, performing addressing and MAC resolution, establishing network protocols, utilizing TCP or UDP protocols, performing data transmissions, and executing error handling procedures. Because the host 104 is performing these communications operations, when an operation executing within the multicore processor 102 provides information to external systems or receives information from external systems via Ethernet link 106, latencies can be experienced based on the PCIe interface and/or host processing delays and timing.

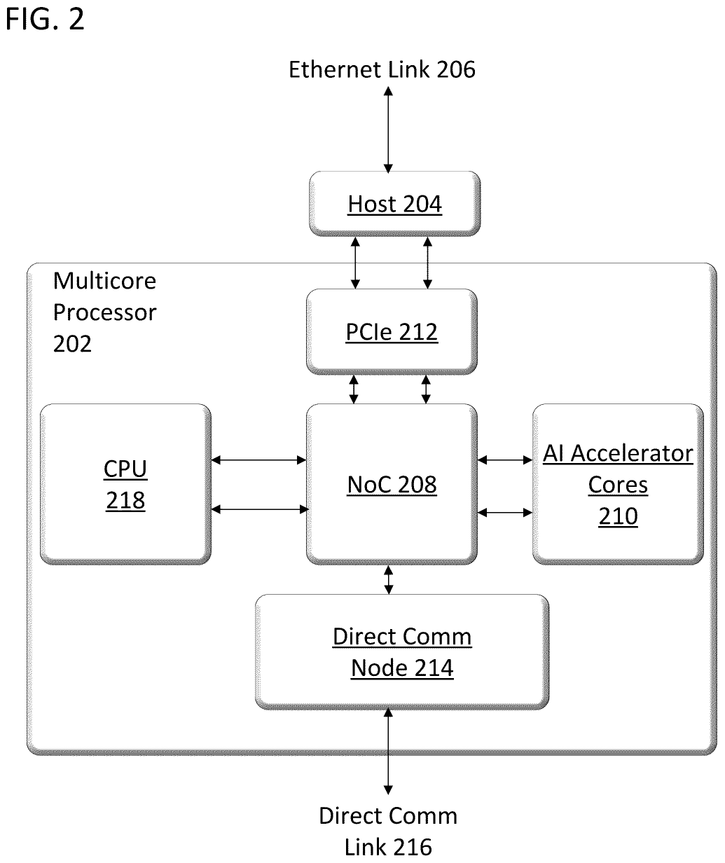

FIG. 2 includes a block diagram of a multicore processor and a direct communication node for direct communication with a direct communication link in accordance with embodiments of the present disclosure. In the embodiment of FIG. 2, like numbered components to FIG. 1 are configured and are capable of operating in a similar manner as described in FIG. 1 (e.g., host 204 is similar to host 104, NoC 208 is similar to NoC 108, AI accelerator cores are similar to AI accelerator cores 210, and PCIe interface 212 is similar to PCIe interface 112), with additional components and functionality to perform direct communications between multicore processor 202 and external components (i.e., via direct communication link 216) as described in FIG. 2. Although it will be understood that a variety of additional components and functionality can be implemented consistent with FIG. 2 and this disclosure, and that particular depicted and described components can be implemented by a variety of underlying hardware components and software configurations, in the exemplary embodiment of FIG. 2 the multicore processor additionally includes a CPU 218 and a direct communication node 214 to enable communication with systems external to the multicore processor 202 via direct communication link 216.

NoC 208 can use a communication protocol (e.g., a proprietary communication protocol) to allow for communication among the AI accelerator cores 210, between the AI accelerator cores 210 and the CPU 218, and between the CPU 218 and the direct communication node 214. For example, based on information available to NoC 208 about the status of accelerator cores 210 (e.g., by monitoring data, status information, communications at nodes, memory, buffers, NIUs, etc.) and the artificial intelligence workload being processed, NoC 208 can obtain real-time information at the individual AI accelerator node level of the AI accelerator cores 210, information about groupings of physical AI accelerator cores 210 (e.g., based on monitoring information at boundaries between groupings of nodes), information about logical groupings of AI accelerator cores 210 (e.g., based on operations, computations, data groupings, etc., as they progress through AI accelerator cores 210), information about other components multicore processor 202 such as CPU 218 and direct communication node 214 (e.g., communication lines, registers, buffers, memory, etc.), and other suitable information and combinations thereof. Further, Noc 208 can provide or inject information at a variety of physical and logical levels of multicore processor 202, including at the level of individual AI accelerator cores 210 and components thereof (e.g., routers, NIUs, memory, buffers, etc.), physical and logical groupings of AI accelerator cores 210, communication links between AI accelerator cores 210 and/or other multicore processor 202 components, and other components of multicore processor 202 such as CPU 218 and direct communication node 214 (e.g., communication lines, registers, buffers, memory, etc.).

CPU 218 can be a processing unit such as a RISC-V CPU (e.g., a general purpose processor core), although other types of processing units can be utilized in other embodiments and for particular implementations. In specific embodiments, CPU 218 can be capable of implementing a full Linux stack. For example, the type and capabilities of CPU 218 can be selected based on the expected processing needs for direct communications between multicore processor 202 and external systems or components via direct communication link 216, other operations to be performed by CPU 218, compatibility with NoC 208 protocols and AI accelerator cores, 210, and other suitable criteria and use cases. Although CPU 218 is depicted and described herein as a dedicated component of a single multicore processor 202, CPU 218 can be implemented in a variety of ways such as a shared CPU that is utilized by multiple multicore processors or multiple CPUs executing instructions.

NoC 208 makes information obtained or available from AI accelerator cores 210 as described herein available to CPU 218 to facilitate CPU 218 performing direct communications with external systems via direct communication node 214 and direct communication link 216. CPU 218 monitors data at the individual core level, for physical groupings of cores, for logical groupings of cores, and/or for the AI accelerators cores as a whole to identify data, communications, events, or other triggers to initiate a direct communication with an external system. For example, based on information available from NoC 208 it can be determined that the AI accelerator cores 210 require, or have a high likelihood to require, data or other information (e.g., commands, statuses, etc.) from an external system. As an example, CPU 218 can monitor information at AI accelerator cores 210 and corresponding requests for data or other information from external sources over time, and based on that monitoring, identify subsets of information that exceed a threshold likelihood of requiring information from an external system. In some embodiments, that threshold likelihood can change based on criteria such as CPU 218 utilization, direct communication node 214 utilization, direct communication link 214 bandwidth and usage, and other information about multicore processor 202.

Based on identifying events for which a direct communication is needed or likely to be needed, CPU 218 initiates a communication to a direct external communication link 216 via NoC 208 (e.g., as depicted in FIG. 2) and/or via a direct bus or other communication interface with direct communication node 214. Facilitating communication via NoC 208 can expedite the transmission of the outgoing message (e.g., including data to be provided to the external system, responses to requests from an external system, commands to an external system, requests for data from the external system, etc.) by accessing information directly from the source within the AI accelerator cores along with any additional overhead information (e.g., header data, time stamps, checksums, etc.) for packaging with that information. CPU 218 can also generate intermediate data, messages, or requests based on information accessed from the AI accelerator cores 210. In some embodiments, the CPU 218 can provide information fully or partially assembled as a message for further processing and transmission via direct communication node 214 and direct communication link 216. Information from the AI accelerator cores 210 and codes or other indicators of actions to be performed can be provided to the direct communication node 214 for further preparation for transmission via direct communication link. Because the local CPU 218 performs these operations in real-time based on present data available within NoC 208, and can further operate in a predictive manner, the speed with which data and messages can be exchanged with an external system is significantly increased versus sending these communications via PCIe 212 and a host 204.

Direct communication node 214 processes ingoing and outgoing communications between the Noc 208 and/or CPU 218 and the direct communication link 216. Direct communication node 214 includes hardware and software that performs required functions for translating messages between a format suitable for transmission and reception by the NoC 208 and/or CPU 218 and a transmission protocol for communicating with the external system or systems via a direct communication link 216. In an exemplary embodiment as described in more detail herein, the direct communication link 216 can be an Ethernet communication link, although other relatively high bandwidth direct communication links 216 (e.g., InfiniBand, multimedia over coax, fiber channel, etc.) can be utilized in other implementations with associated modifications to the hardware and software of direct communication node 214. In other embodiments, wireless or other wired protocols can be utilized with appropriate modifications to the hardware and software of direct communication node 214.

The NoC 208 can be controlled by the CPU 218 to provide data available from the AI accelerator cores 210 and certain status or control indicators to the direct communication node 214, with the direct communication node 214 configured to properly generate and dispatch messages to the direct communication link 216, leaving the processing of the CPU 218 to focus on identification of events for expedited communication processing and other related analyses of information available via NoC 208. Similarly, for responses or other incoming requests from external systems via the direct communication link 216, direct communication node 214 receives an incoming communication from the direct communication link and appropriately processes the incoming message to parse out and deliver to NoC 208 and/or CPU 218 information such as a streamlined data set that provides responsive information and minimal necessary information as necessary to retain context (e.g., message or operation sequence, relevant nodes or operations, etc.) for the received data set to be processed appropriate by the CPU 218 and NoC 208.

NoC 208 receives incoming information from direct communication node 214 and with CPU 218 processes that incoming information for use within AI accelerator cores 210. The received information can include data, instructions, requests, or any other suitable information for use in the control and operation of the AI accelerator cores 210. For example, CPU 218 can process received information that includes indicators that data is to be provided to one or more AI accelerator cores 210, the underlying data, and information necessary to store the data in the correct location. For example, data required for use in a complex computation of the AI accelerator cores 210 can be provided to one or more cores via an internal communication channel (e.g., via a router and/or NIU of the core) or directly to memory locations within the multicore processor 202 or individual cores of the AI accelerator cores 210 based on the received information. As another example, received information can also include instructions processed by CPU 218 to cause the NoC 208 to modify the operations of AI accelerator cores 210, for example, to prioritize certain workloads based on an external request or condition. As another example, received information can also include instructions processed by CPU 218 to cause the NoC 208 to access underlying data, intermediate communications, or status data for the AI accelerator cores 210, for return to the external system via the direct communication link 216. It will be understood that these are just some examples of the types of information and operations that can be initiated and/or performed based on received information from the direct communication node. Engaging in communications in this manner provides more timely and granular access to data and operational information for the AI accelerator cores than communications via PCIe 212 and host 204, thus enabling a substantial set of controlled optimizations for particular tasks, workloads, and hardware and software configurations and reducing concerns about latency and variations in latency.

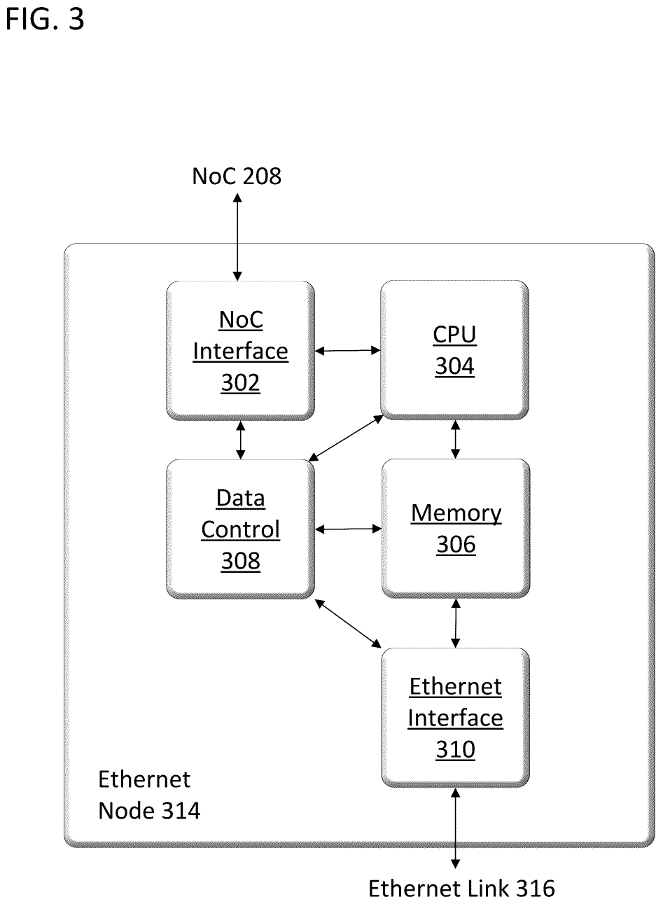

FIG. 3 includes a block diagram of an Ethernet node interfacing between a NoC of a multicore processor and an Ethernet link in accordance with embodiments of the present disclosure. An Ethernet node functions as an Ethernet communications subsystem or a Ethernet communications subsystem core. As described herein, an exemplary direct communication node 214 can be an Ethernet node 314 and the direct communication link 216 for communication with the external systems can be an Ethernet link 316. As described herein, Ethernet node 314 exchanges information between NoC 208 and/or CPU 218 in a suitable format for simplified processing by the CPU 218 and NoC 208 (e.g., in some embodiments, a limited subset of instructions and/or related indicators with data to be exchanged) and Ethernet link 316 (e.g., with appropriate such link establishment, addressing, MAC resolution, network protocols, TCP or UDP protocols, error handling procedures, and PHY layer communications). Although components can be combined, removed, or modified in some embodiments, in the embodiment of FIG. 3 Ethernet node 314 includes a NoC interface 302, a CPU 304, data control circuitry and logic, memory 306, and Ethernet interface 310.

In specific embodiments, information received at the NoC interface 302 from NoC 208 and/or CPU 218 (e.g., as control information and data from the CPU of multicore processor, etc.) is monitored and processed by NoC interface 302 to determine whether the information is intended for transmission via Ethernet link 316, for example, based on addresses, headers, or other indicators from NoC 208. NoC interface 302 then processes the outgoing information for further preparation as data packets suitable for transmission via Ethernet link 316, for example by providing control information for processing by CPU 304 and underlying data for processing by data control 308. Although particular data paths are depicted in FIG. 3, it will be understood that outgoing information from NoC 208 can be processed via a variety of internal paths, e.g., initially through CPU 304, initially to data control 308, or simultaneously to both. For outgoing or configuration requests from NoC 208 and/or CPU 218, a confirmation can be provided to NoC 208 and/or CPU 218 once the requested action is completed. For incoming messages originally received via Ethernet link 316, the Ethernet interface 310 confirms that the information is intended for NoC 208 (e.g., based on addresses, headers, or other indicators), the incoming message is processed (e.g., by Ethernet interface 310, data control circuitry 308, CPU 304, and memory 306), NoC interface 302 performs any final processing necessary to prepare the data for distribution to NoC 208 and CPU 218, and NoC interface 302 distributes the information to the NoC 208 and CPU 218 (e.g., through NoC 208) for use by AI processing cores 210.

In specific embodiments, the Ethernet node 314 will include a lower power CPU 304 (e.g., as compared to CPU 218) that can be used to configure and control the operation of components of the Ethernet node 314. The CPU 304 is lower power in terms of its programmability and instructions set as compared to the CPU 218 that is serving as the general-purpose processor in FIG. 2. The lower power CPU 304 can store its instructions in memory 306 and can also receive instructions for execution from the higher power CPU 218 (e.g., via NoC 208, NoC interface 302, and or data control circuitry 308). The lower power CPU 304 can also write data to components of data control circuitry 308 to change operations of components of the Ethernet node 314 (e.g., modifying a configuration of the Ethernet interface 310). CPU 304 further interfaces with data control circuitry 308 and memory 306 to format, package, schedule, and otherwise facilitate the exchange of information between NoC 208 and Ethernet interface 310.

Data control circuitry 308 provides a variety of data control and configuration functions for Ethernet node 314. Data control circuitry can monitor, change, and control data paths, registers, memory locations, and other circuitry within Ethernet node 314 such that outgoing information from NoC 208 is appropriately packaged and scheduled for transmission to Ethernet Link 316 while incoming messages from Ethernet link are deconstructed and formatted as appropriate for expedited processing by NoC 208 and CPU 218, and in turn, AI accelerator cores 210.

In specific embodiments, memory 306 is a suitable memory that provides for storage of instructions for execution by CPU 304 as well as buffering and temporary storage for data, messages, or other information being exchanged between NoC 208 and Ethernet link 316. Although depicted as a single memory unit, it will be understood that memory 306 can include a variety or multiple memory types suited for different purposes, such as storing code for execution by CPU 304, temporarily storing working data or status information for CPU 304, or providing high-speed access to buffered data or messages (or portions thereof) for exchange between NoC 208 and Ethernet link 316.

In specific embodiments, packets received at the Ethernet interface 310 from Ethernet link 316 are monitored and processed by Ethernet interface 310 to determine whether the information is intended for transmission to NoC 208, for example, based on addresses, headers, or other indicators within the data packet. Ethernet interface 310 then provides the message for further preparation as data portions suitable for use by NoC 208 and/or CPU 218 for control or operation of AI accelerator cores 210, for example, for parsing, fragmentation, packet disassembly, decomposition, or other suitable methods. In some embodiments, aspects of this processing are performed by CPU 304, data control 306, and/or memory 306, for example, with Ethernet interface 310 primarily responsible for PHY and MAC level processing and other low level control operations. For outgoing messages prepared based on information originally received from NoC 208 and/or CPU 218, Ethernet interface 310 performs any final processing necessary to prepare packets for transmission over Ethernet link 316.

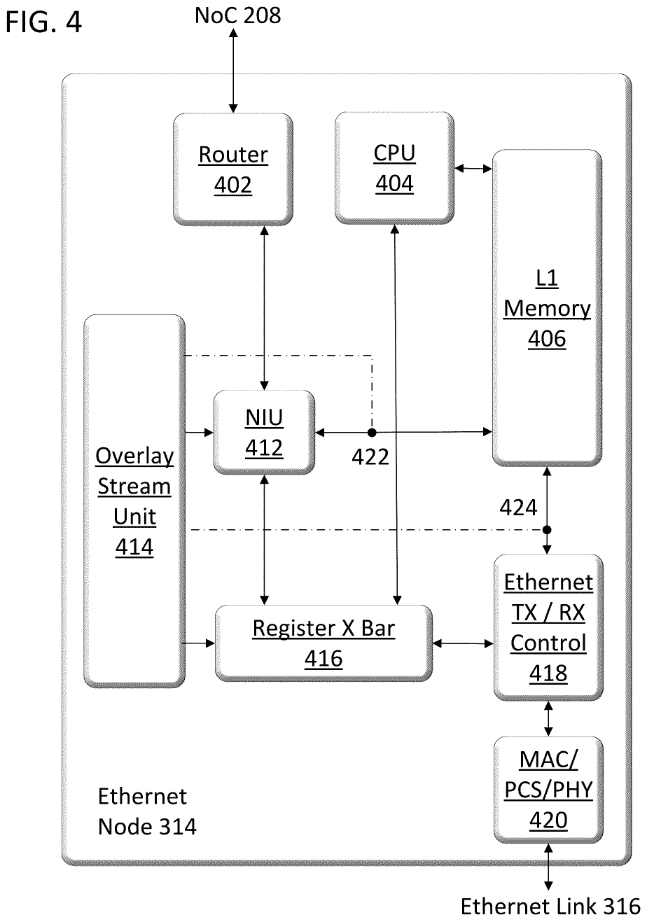

FIG. 4 includes a block diagram of an Ethernet node and components thereof interfacing between a NoC of a multicore processor and an Ethernet link in accordance with embodiments of the present disclosure. In specific embodiments, components depicted and described in FIG. 4 correspond to specific implementations of components depicted and described in FIG. 3 as applied to a particular implementation of Ethernet node 314, with router 402 and network interface unit (NIU) 412 corresponding to NoC interface 302, CPU 404 corresponding to CPU 304, L1 memory 406 corresponding to memory 306, overlay stream unit 414 and register X bar 416 corresponding to data control circuitry 308, and Ethernet transmit (TX) and receive (RX) circuitry 418 and MAC/PCS/PHY circuitry 420 corresponding to Ethernet interface 310. Ethernet node 314 of FIG. 4 further includes monitoring node 422 for monitoring a data communication path between L1 memory 406 and NIU 412 and monitoring node 424 for monitoring a data communication path between L1 memory 406 and Ethernet TX/RX control 418.

In specific embodiments, packets received at router 402 from NoC 208 will be passed to the NIU 412 if the packets are intended for consumption by the Ethernet node 314 (e.g., based on addresses, headers, or other indicators within the data provided from NoC 208). The NIU 412 then processes the received information from NoC 208 to determine what processing should be performed within Ethernet node 314. For example, the information from the NoC 208 (e.g., as controlled by CPU 218) can directly (e.g., via specific commands or indicators) or indirectly (e.g., via an analysis by NIU 412 of the information received from NoC 208) indicate the action to be performed by the Ethernet node 314, such as to transmit data via the Ethernet link 316, transmit requests or responses via the Ethernet link 316, or to modify configuration information for the Ethernet node, selection of protocols (e.g., TCP, UDP, etc.), initialization and teardown of links, discovery of external systems, and other suitable functionality as necessary for configuration and operation of Ethernet link 316 and communications over that link. For outgoing or configuration requests from NoC 208 and/or CPU 218, a confirmation can be provided to NoC 208 and/or CPU 218, such as when the requested action is completed.

In specific embodiments, the NIU 412 can either pass the data to the register cross (X) bar in order to program the Ethernet controller 418 or to the shared L1 memory 406 to be sent by the Ethernet controller. The overlay stream unit 414 can snoop the data lines using the dotted lines in the diagram (e.g., monitoring node 422 for monitoring a data communication path between L1 memory 406 and NIU 412 and monitoring node 424 for monitoring a data communication path between L1 memory 406 and Ethernet TX/RX control 418) and administrate the transfer of data between the illustrated components and external systems or nodes of the multicore processor. For example, the overlay unit can be in accordance with those disclosed in U.S. patent application Ser. No. 17/035,046 as filed on Sep. 28, 2020 (issued as U.S. Pat. No. 11,734,224), which is incorporated by reference herein in its entirety for all purposes. The aforementioned components of the Ethernet node can receive messages sent using the NoC 208 protocol, such as messages sent by the CPU 218, and use them to configure the Ethernet TX/RX controller 418.

In specific embodiments, the Ethernet node 314 will include a lower power CPU 404 (e.g., as compared to CPU 218) that can also be used to configure and control the operation of components of the Ethernet node 314. The CPU 404 is lower power in terms of its programmability and instructions set as compared to the CPU 218 that is serving as the general-purpose processor in FIG. 2. The lower power CPU 404 can store its instructions in L1 memory 406 and can also receive instructions for execution from the higher power CPU 218 (e.g., as depicted in FIG. 4, via NoC 208, NIU 412, and register X bar 416). The lower power CPU 404 can also write data to register X bar 416 to change operations of components of the Ethernet node 314 (e.g., modifying a configuration of the Ethernet TX/RX control 418). CPU 404 further interfaces with register X bar 416 and L1 memory 406 to format, package, schedule, and otherwise facilitate the exchange of information between NoC 208 and Ethernet TX/RX control 310. MAC/PCS/PHY circuitry 420 controls media access control processing, physical coding sublayer operations, and physical layer communications with the Ethernet link 316 based on the information to be transmitted and the configuration of the Ethernet TX/RX controller 418.

When data is received from the Ethernet link 316, initial processing is performed by MAC/PCS/PHY circuitry 420 and the resulting message is forwarded to Ethernet TX/RX controller 418. Ethernet TX/RX controller 418 extracts the underlying information for forwarding to NoC 208 and CPU 218, and provides the extracted information to L1 memory 406 for temporary storage before further processing within Ethernet node 314. The overlay stream unit 414 utilizes monitoring node 424 to monitor a data communication path between Ethernet TX/RX control 418 and L1 memory 406 and can then administrate a transfer of that data using the NIU 412. The data is processed for transmission to the NoC 208 in a format suitable for processing by NoC 208 and CPU 218 using the proprietary NoC protocol of the multicore processor by CPU 404 (e.g., interacting with L1 memory 406 and updating data therein) and/or NIU 412. NIU 412 then routes the data, properly processed for use by NoC 208 and CPU 218 to update or control operations and data within AI accelerator cores 210, to the NoC 208 and CPU 218 via router 402. In this manner, the AI accelerator cores 210 can obtain requested data from an Ethernet link without having to conduct the difficult task of configuring a fully functioning Ethernet link and sending and receiving data thereon.

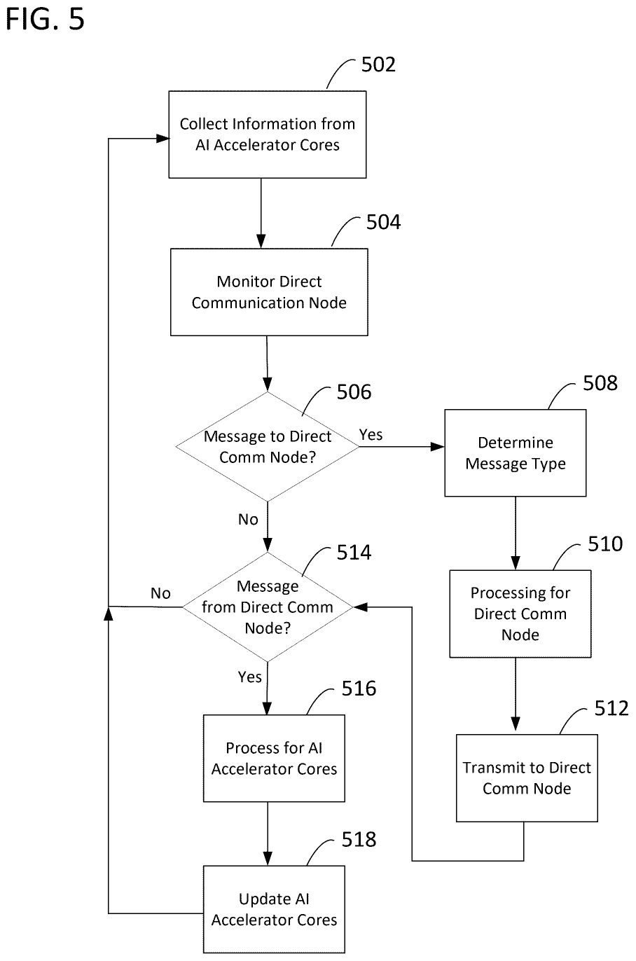

FIG. 5 includes a flow chart for methods for a NoC interfacing between a CPU and AI accelerator cores of a multicore processor for providing direct communications with an external communication link in accordance with embodiments of the present disclosure. Although certain steps are depicted in a particular order in FIG. 5, it will be understood that steps can be added or removed, and that the order of steps can be modified consistent with the present disclosure. Further, although certain hardware, software, operations, and functionality is described as performing certain steps of FIG. 5, it will be understood that the steps described in FIG. 5 can be performed utilizing other hardware, software, operations, and functionality consistent with the present disclosure.

At step 502, information is collected from AI accelerator cores. In specific embodiments, a NoC can have low-level access to information stored, communicated, and instructed within AI accelerator cores, physical groupings of AI accelerator cores, logical groupings of AI accelerator cores, supporting hardware and executing software associated with AI accelerator cores, and other hardware, communications, and software as described herein. This information can be utilized for a variety of purposes such as to identify conditions where direct communication with a direct communication link is required or to predictively identify events that are highly likely to require a direct communication and preemptively fetching information or sending requests, or to train the system to identify either of these events based on the CPU of the multicore processor comparing conditions monitored by the NoC with interactions with external systems. Once the NoC has collected information from the AI accelerator cores, processing continues to step 504.

At step 504, the NoC and/or CPU monitor communications from the direct communication node. It will be understood that while steps 502 and 504 are described as a sequence of operations for purposes of the present flow diagram, the monitoring steps of 502 and 504 can be performed in parallel. A router of the direct communication node (e.g., an Ethernet node) communicates with the NoC and/or CPU in a format that can be used to discern a type of incoming information from the direct communication node, and in turn, how the NoC and CPU should process incoming information from the direct communication node. Information received can include acknowledgments, status messages, and other similar information provided by the direct communication in response to communications provided from NoC 208. Information received also includes underlying data and communications originating from external sources via the direct communication link. Processing then continues to step 506.

At step 506, it is determined whether a message is to be sent to the direct communication node based on the information collected at step 502, and in some instances, based on acknowledgments or other responses from the direct communication node received at step 504. Based on this information available to the CPU, operating routines of the CPU, analysis of historical data, and other suitable data and information, the CPU determines whether a message such as a response, request, and/or underlying data should be sent to the direct communication node. If a message is to be sent to the direct communication node, processing continues to step 508. If no message is to be sent, processing continues to step 514.

At step 508, the CPU determines the message type for transmission to the external system via the direct communication link. Examples of message types include status responses, data stored in memory, data being communicated between AI accelerator cores, intermediate computation data, requests for data or status information from external systems, and other suitable data supporting the operations and computations of the AI accelerator cores. Other types of messages can relate to configuration of the direct communication node, for example, to modify protocols, set up communication links, connect with external devices, and other related operations. This processing can determine formatting of information to be provided to the direct communication node, generation of control values, additional calculations or permutations of data (e.g., based on a type of external system), and other similar operations. Once the message type has been determined, processing continues to step 510.

At step 510, based on the determination of step 508 and the underlying information to be transmitted, the CPU processes the data into a format suitable for processing by the direct communication node. For example, a router and NIU of the direct communication node can recognize certain headers or other indicators, or underlying data formats and types, as relating to particular operations such as configuration operations, data transmissions, request messages, and other suitable types of requests. CPU can format the information in a manner understandable to the router and NIU for appropriate routing within the direct communication node. Processing then continues to step 512.

At step 512, the CPU transmits the information to the direct communication node such as via the NoC. A NoC interface of the direct communication node such as a router and NIU receives the information and processes it appropriately, for example, to modify a configuration of the direct communication node or to transmit a message to an external system via the direct communication link. In some instances, additional messaging can be exchanged between the direct communication node (e.g., at the direction of a CPU of the direct communication node) and the CPU associated with the NoC and AI accelerator cores to complete certain actions. Processing then continues to step 514. It will be understood that the processing of the loop starting at 506 and continuing through 512 and the processing of the loop starting at 514 and ending at 518 can be conducted in different orders or in parallel.

At step 514 it is determined by the NoC and/or CPU whether a message is being received from the direct communication node. As described herein, a variety of message types can be received at the NoC and/or CPU from the direct communication node, such as incoming data, control messages, responses to configuration messages, acknowledgments, and other content of messages received from external systems via the direct link. If a message is being received from the direct communication node, processing continues to step 516. If a message is not being received from the direct communication node, processing returns to step 502 to continue the monitoring and processing steps of FIG. 5.

At step 516, the CPU associated with the NoC and AI accelerator cores receives and processes the received message such as for use at the AI accelerator cores. For example, based on headers, indicators, underlying data, or other information provided according to a known format for exchanging information between the CPU and direct communication node. If a received message is simply an acknowledgement of a configuration change to the direct communication node or other similar message that does not impact the operation of the AI accelerator cores, further processing with the AI cores is not required (not specifically depicted in FIG. 5). If the received message includes information for use with the AI accelerator cores such as data to be used in computations, updates to memory values, initiation of computations, procedures or parameters for computations, or any other information for use with the AI accelerator cores, the CPU prepares the relevant information for distribution to the AI accelerator cores, related circuitry, or portions thereof. Processing then continues to step 518.

At step 518, the NoC distributes the information provided by the CPU to the appropriate locations within the AI accelerator cores and related circuitry, such as by modifying control parameters, propagating messages through the NoC, changing values in memory, updating executable code, providing instructions, and other suitable operations. Once the information has been provided via the NoC to the AI accelerator cores, processing returns to step 502.

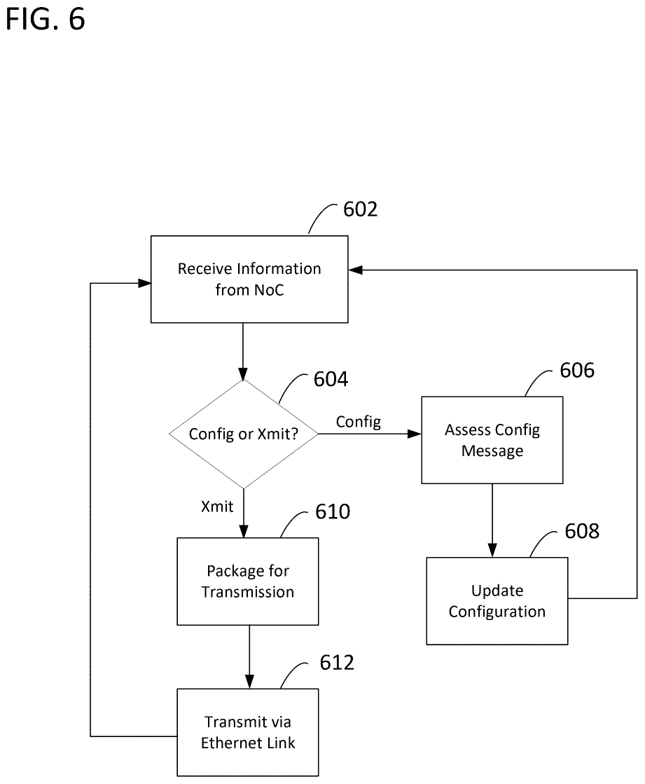

FIG. 6 includes a flow chart for methods for a multicore processor communicating data from a NoC to an Ethernet link via an Ethernet node in accordance with embodiments of the present disclosure. Although certain steps are depicted in a particular order in FIG. 6, it will be understood that steps can be added or removed, and that the order of steps can be modified consistent with the present disclosure. Further, although certain hardware, software, operations, and functionality were described with respect to the performance of certain steps of FIG. 6, it will be understood that the steps described in FIG. 6 can be performed utilizing other hardware, software, operations, and functionality consistent with the present disclosure. Although FIG. 6 will be described in the context of Ethernet communications, it will be understood that the steps of FIG. 6 can similarly apply to other types of direct communication links and direct communication nodes.

At step 602, processing is initiated when information is received from a NoC and/or CPU of the multicore processor, for example, at a router of an Ethernet node. The router screens received communications (e.g., from multiple NoCs and/or CPUs or other systems in some embodiments) to confirm that the messages are in fact intended for processing by the Ethernet node. Messages received at the router that are intended for processing by the Ethernet node are passed to other components of the Ethernet node, such as an NIU and/or lower-power CPU of the Ethernet node. Processing then continues to step 604.

At step 604, the Ethernet node (e.g., NIU and/or lower-power CPU) determines the type of message that is being received from the NoC based on headers, indicators, the underlying data, or other suitable information pursuant to a known data exchange format. Although other message types can be utilized in some embodiments, in specific embodiments a message can be either a configuration message for the Ethernet node or a transmit message to be sent to an external system via the Ethernet link. If the message is a configuration message processing continues to step 606. If the message is a transmit message processing continues to step 610.

At step 606 the Ethernet node processes the configuration message to determine steps to be performed for configuration of the Ethernet node. In specific embodiments configuration messages can control configuration of parameters such as establishing or closing links, controlling procedures for addressing and MAC resolution, establishing network protocols, utilizing TCP or UDP protocols, setting error handling procedures, and other suitable operations of the Ethernet hardware, software, and communication link. Processing then continues to step 608.

At step 608 the configuration is updated, such as by the NIU and/or CPU updating information at the register X bar of the Ethernet node, which in turn is utilized to update the operation of the Ethernet transmit and receive controller and/or MAC/PCS/PHY circuitry in accordance with the configuration message. In this manner, the CPU associated with the AI accelerator cores can directly control the establishment, setup, and communications of the Ethernet link without needing to communicate via a host. Once the configuration is complete, processing returns to step 602 to receive additional information from the NoC.

Processing arrives at step 610 if at step 604 the received message is determined to be a transmit message at step 604. At step 610, the NIU can pass data to the shared memory to be sent by the Ethernet transmit and receive controller. The overlay stream unit can snoop the data line between the NIU and memory and administrate the transfer of data between the Ethernet components and external systems or nodes of the multicore processor. Processing then continues to step 612.

At step 612, the information to be transmitted vie the Ethernet link is formatted, packaged, scheduled, and otherwise prepared for transmission by the Ethernet transmit and receive controller. The packaged message (e.g., each Ethernet packet) is provided to MAC/PCS/PHY circuitry that controls media access control processing, physical coding sublayer operations, and physical layer communications with the Ethernet link and transmits the packets over the Ethernet link.

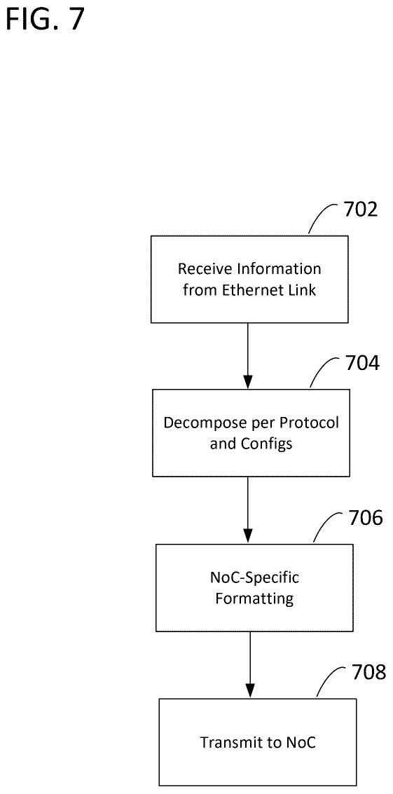

FIG. 7 includes a flow chart for methods for a multicore processor communicating from an Ethernet link to a NoC via an Ethernet node in accordance with an embodiments of the present disclosure. Although certain steps are depicted in a particular order in FIG. 7, it will be understood that steps can be added or removed, and that the order of steps can be modified consistent with the present disclosure. Further, although certain hardware, software, operations, and functionality is described in performing certain steps of FIG. 7, it will be understood that the steps described in FIG. 7 can be performed utilizing other hardware, software, operations, and functionality consistent with the present disclosure. Although FIG. 7 will be described in the context of Ethernet communications, it will be understood that the steps of FIG. 7 can similarly apply to other types of direct communication links and direct communication nodes.

At step 702 information is received at the Ethernet node, for example, at the MAC/PCS/PHY circuitry. This circuitry performs physical layer processing, physical coding sublayer operations, and media access control processing to provide a suitable message at a higher level of the open systems interconnection (OSI) stack suitable for processing by the Ethernet TX/RX controller. Processing continues to step 704.

At step 704, the Ethernet TX/RX controller performs higher-level OSI operations to extract the underlying information for forwarding to the NoC and CPU, and provides the extracted information to L1 memory for temporary storage before further processing within Ethernet node 314. The overlay stream unit utilizes a monitoring node to monitor a data communication path between the Ethernet TX/RX control and L1 memory and can then administrate a transfer of that data using the NIU. Processing then continues to step 706.

At step 706, the NIU and/or CPU of the Ethernet node perform any NoC-specific processing to prepare the message for transmission to the NoC and processing by the CPU associated with the NoC and AI accelerator cores in accordance with the NoC protocol. The NIU and/or CPU of the Ethernet node interacting with the L1 memory then routes the data or other information, properly processed for use by the NoC and CPU, to the router. Processing then continues to step 708.

At step 708, the router of the Ethernet node transmits the NoC-formatted information to the NoC and/or CPU. That information is then utilized by the NoC and CPU to update or control operations and data within the AI accelerator cores 210. In this manner, the AI accelerator cores can obtain requested data and otherwise interact with systems via an Ethernet link without having to conduct the difficult task of configuring a fully functioning Ethernet link and sending and receiving data thereon. Once the information is provided to the NoC, the processing of the Ethernet node described in FIG. 7 ends.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A multicore processor comprising:
a set of artificial intelligence (“AI”) accelerator cores;
at least one Ethernet node;
at least one central processing unit (“CPU”); and
a network on chip (“NoC”) that networks the set of AI accelerator cores, the at least one Ethernet node, and the CPU, wherein the CPU executes instructions to administrate Ethernet transfers over an Ethernet link for the set of AI accelerator cores using the at least one Ethernet node.

2. The multicore processor of claim 1, wherein the Ethernet link comprises a first Ethernet link, and wherein the Ethernet transfers are performed without utilizing a host that is in communication with the multicore processor or a second Ethernet link connected to the host.

3. The multicore processor of claim 1, wherein the NoC collects information from the AI accelerator cores for use by the CPU to administrate the Ethernet transfers.

4. The multicore processor of claim 3, wherein the information collected from the AI accelerator cores comprises information from one or more of the AI accelerator cores, information from a physical grouping of AI accelerator cores, or information from a logical grouping of AI accelerator cores.

5. The multicore processor of claim 3, wherein the information collected from the AI accelerator cores comprises information accessed from memory of one or more of the AI accelerator cores or information from communications between AI accelerator cores.

6. The multicore processor of claim 3, wherein, based on the information collected from the AI accelerator cores, the CPU determines that one or more of the AI accelerator cores require access to data from an external system via the Ethernet link, and wherein the determination causes the CPU to execute the instructions.

7. The multicore processor of claim 3, wherein, based on the information collected from the AI accelerator cores, the CPU predicts that one or more of the AI accelerator cores will require access to data from an external system via the Ethernet link, and wherein the prediction causes the CPU to execute the instructions.

8. The multicore processor of claim 1, wherein the instructions to administrate Ethernet transfers comprise configuration instructions and transmit instructions, wherein the CPU executes the configuration instructions to configure the at least one Ethernet node to establish Ethernet communications over the Ethernet link with an external system, and wherein the CPU executes the transmit instructions to transmit messages to the external system over the Ethernet link after the Ethernet communications are established.

9. The multicore processor of claim 8, wherein the configuration instructions cause the at least one Ethernet node to establish or close links, set procedures for MAC resolution, establish network protocols, select between transmission control protocol (“TCP”) or user datagram protocol (“UDP”) protocols, or set error handling procedures.

10. The multicore processor of claim 1, wherein the CPU comprises a first CPU, and wherein each Ethernet node of the at least one Ethernet node comprises:
a router configured to communicate with the NoC;
a network interface unit (“NIU”) configured to administrate operations within the at least one Ethernet node;
a second CPU, wherein the second CPU comprises a lower-power CPU than the first CPU, and wherein the second CPU is configured to execute instructions to configure operations of the Ethernet node;
a memory comprising the instructions to configure operation of the at least one Ethernet node and storage for data to be exchanged between the NoC and the Ethernet link; and
an Ethernet interface configured to prepare messages to be transmitted over the Ethernet link and to process messages received from the Ethernet link.

11. The multicore processor of claim 10, further comprising an overlay stream unit configured to monitor exchanges of data between the NIU and the memory and coordinate transmissions of the messages over the Ethernet link.

12. The multicore processor of claim 11, wherein the overlay stream unit is further configured to monitor exchanges of data between the Ethernet interface and the memory to coordinate processing of data received via the Ethernet link.

13. The multicore processor of claim 10, further comprising a register cross bar, wherein the register cross bar communicates with the second CPU to initiate changes to a configuration of the Ethernet interface based on the CPU executing the instructions to configure operations.

14. The multicore processor of claim 10, wherein the Ethernet interface comprises an Ethernet transmit/receive controller and a MAC/PCS/PHY controller, wherein the Ethernet transmit/receive controller controls a transmission and reception of messages over the Ethernet link and the MAC/PCS/PHY controller performs media access control processing, physical coding sublayer operations, and physical layer communications for the Ethernet link.

15. A method for a multicore processor to directly communicate via an Ethernet link, comprising:
monitoring, by a network on chip (“NoC”), a set of artificial intelligence (“AI”) accelerator cores;
determining, by a central processing unit (“CPU”) of the multicore processor based on the monitoring, that the AI accelerator cores require information that is available via the Ethernet link;
generating, by the CPU, a message for transmission via the Ethernet link;
providing, by the CPU via the NoC, the message for transmission to an Ethernet node of the multicore processor;
processing, by the Ethernet node, the message for transmission as packets for transmission over the Ethernet link; and
transmitting, by the Ethernet node, the packets over the Ethernet link.

16. The method of claim 15, further comprising:
determining, by the CPU based on the monitoring of the AI accelerator cores, that a configuration of the Ethernet link requires modification;
providing, from the CPU to the Ethernet node via the NoC, an instruction to modify the configuration of the Ethernet link; and
modifying, by the Ethernet node based on the instruction, the configuration of the Ethernet link.

17. The method of claim 15, wherein the monitoring comprises monitoring information from one or more of the AI accelerator cores, information from a physical grouping of AI accelerator cores, or information from a logical grouping of AI accelerator cores.

18. An artificial intelligence processing system, comprising:
a host processor;
a first Ethernet link connected to the host processor; and
a multicore processor in communication with the host processor, the multicore processor comprising:
a set of artificial intelligence (“AI”) accelerator cores;
at least one Ethernet node;
at least one central processing unit (“CPU”); and
a network on chip (“NoC”) that networks the set of AI accelerator cores, the at least one Ethernet node, and the CPU,
wherein the CPU executes instructions to administrate Ethernet transfers over a second Ethernet link directly accessible to the multicore processor for the set of AI accelerator cores using the at least one Ethernet node, and wherein the Ethernet transfers are performed without utilizing the host processor or the first Ethernet link.

19. The artificial intelligence processing system of claim 18, wherein the NoC collects information from the AI accelerator cores for use by the CPU to administrate the Ethernet transfers.

20. The artificial intelligence processing system of claim 19, wherein the information collected from the AI accelerator cores comprises information from one or more of the AI accelerator cores, information from a physical grouping of AI accelerator cores, or information from a logical grouping of AI accelerator cores.
